(19) United States
(12) Patent Application Publication
(10) Pub. No.: US 2010/0083020 A1
(43) Pub. Date: Apr. 1, 2010

(54) INFORMATION PROCESSING SYSTEM AND CONTROL METHOD THEREOF

(75) Inventor: Motoharu Suzuki, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/560,908

(22) Filed: Sep. 16, 2009

(30) Foreign Application Priority Data
Sep. 29, 2008 (JP) 2008-251685

(51) Int. Cl. G06F 1/32

(52) U.S. Cl. 713/322; 713/320

(57) ABSTRACT

An information processing system comprising a main system which executes an application, and a subsystem which controls communication with an external apparatus, the information processing system having a power saving mode in which power consumption of the information processing system is reduced, the main system including a power control unit configured to control power consumption of the subsystem, the subsystem including a first communication processing unit configured to communicate with the external apparatus, a second communication processing unit configured to communicate with the external apparatus, and a control unit for the subsystem, wherein when the information processing system shifts to the power saving mode, the power control unit controls power consumption of the subsystem in the power saving mode in accordance with a type of instruction sent from the external apparatus to accept cancellation of the power saving mode.

### BACKGROUND OF THE INVENTION

1. Field of the Invention

The present invention relates to an information processing system and control method thereof.

2. Description of the Related Art

PCs (Personal Computer) and their peripheral devices adopt a so-called power management function. The power management function is expected to become necessary in a wide variety of information processing systems which will come into the market. ACPI (Advanced Configuration and Power Interface) is known as a standard of the power management function used in PCs and the like (see “Advanced Configuration & Power Interface” Revision 3.0b Oct. 10, 2006, Internet <URL: http://www.acpi.info/>).

ACPI defines the following power modes:

S0 working state (normal operation state)

S1 low power consumption state (both the CPU and chip set are ON)

S2 low power consumption state (the CPU and cache are OFF and the chip set is ON)

S3 standby state

S4 idle state (hibernation)

S5 soft off

While an apparatus is idle, the current power management function stops some functions to reduce power consumption, and shifts (transits) the apparatus to a power saving mode, for example, so-called sleep mode (one of the power modes S1 to S5 in the case of ACPI). The power management function returns the apparatus to a normal mode (S0 in the case of ACPI) in response to a user operation to the apparatus or access from an external apparatus.

There is also known an arrangement for returning from a low power consumption mode upon detecting access to an interface for communicating with an external device. For example, a network interface such as Ethernet® has a WOL (Wake-On-LAN) function.

Upon receiving a specific packet via a network interface, the WOL returns an information processing system from a power saving mode. Several specific packets have been proposed for use in the WOL. For example, MagicPacket® developed by AMD is known.

MagicPacket is an Ethernet packet of a special format in which the information field of a frame is generated from the MAC address of a target apparatus. The packet can activate (only) a target device. A MagicPacket-compliant network interface is configured to respond to the pattern of the packet. When the network interface recognizes its MAC address, it outputs a signal for activating the entire apparatus.

As for the WOL function, there is proposed a technique in which an external device causes a computer having a serial bus interface to perform a wakeup operation (see Japanese Patent Laid-Open No. 2000-209220). There is also proposed a technique concerning the state of a sub CPU incorporated in a communication unit and power supply control upon executing WOL (see Japanese Patent Laid-Open No. 2005-267099).

Other techniques are also proposed, including WOWLAN (Wake-On-Wireless LAN) which is an expansion of the WOL function to wireless communication (see Japanese Patent Laid-Open No. 2005-244329).

### SUMMARY OF THE INVENTION

When an information processing system is in the power saving mode, the subsystem of the information processing system is desirably in the power saving mode, too. However, power supply to the subsystem cannot be completely stopped when returning the information processing system from the power saving mode to a normal mode via a network interface such as WOL.

When WOWLAN is used, the information processing system needs to maintain a connection of wireless communication to another device. The subsystem requires processing different from that for WOL used in wired communication. Even when WOL or WOWLAN is used, the subsystem sometimes requires additional operations such as a response to a specific packet and exchange of a key necessary for packet encryption while the information processing system is in the power saving mode.

It is therefore necessary to control the power saving mode of the subsystem stepwise in accordance with the contents of processing requested of the subsystem when the information processing system is in the power saving mode.

According to one aspect of an exemplary embodiment, the present invention relates to an information processing system comprising a main system which executes an application, and a subsystem which controls communication with an external apparatus, the information processing system having a power saving mode in which power consumption of the information processing system is reduced, the main system including a power control unit configured to control power consumption of the subsystem, the subsystem including a first communication processing unit configured to communicate with the external apparatus, a second communication processing unit configured to communicate with the external apparatus, and a control unit for the subsystem, wherein when the information processing system shifts to the power saving mode, the power control unit controls power consumption of the subsystem in the power saving mode in accordance with a type of instruction sent from the external apparatus to accept cancellation of the power saving mode.

According to another aspect of an exemplary embodiment, the present invention relates to an information processing system comprising a main system which executes an application, and a subsystem which controls communication with an external apparatus, the main system including, an acquisition unit configured to acquire information on a power saving mode of the subsystem from the subsystem, and a power control unit configured to control power supply to the main system and the subsystem, the subsystem including a first controller which performs wired communication with the external apparatus, a second controller which performs wireless communication with the external apparatus, and a control unit for the subsystem, wherein when the subsystem shifts to the power saving mode, the power control unit controls power supply to at least the control unit, the first controller, and the second controller in accordance with the information acquired by the acquisition unit, and the power saving mode includes a first power saving mode in which power is supplied to the first controller without supplying power to the control unit, and a second power saving mode in which power is supplied to the control unit and at least either of the first controller and the second controller.

According to further aspect of an exemplary embodiment, the present invention relates to an information processing system comprising a main system which executes an application, and a subsystem which controls external communication, the main system including a control unit configured to control power supply to the subsystem, the subsystem including a first controller which performs wired communication, a second controller which performs wireless communication, and a control unit for the subsystem, wherein when the subsystem shifts to a power saving mode, the control unit controls power supply to the control unit, the first controller, and the second controller in accordance with a communication standby state of the subsystem.

According to yet further aspect of an exemplary embodiment, the present invention relates to a method of controlling an information processing system including a main system which executes an application, and a subsystem including a first communication processing unit and second communication processing unit configured to communicate with an external apparatus, and a control unit, the information processing system having a power saving mode in which power consumption of the information processing system is reduced, the method comprising determining whether to shift the information processing system to the power saving mode, and when the information processing system shifts to the power saving mode, controlling power consumption of the subsystem in the power saving mode in accordance with a type of instruction sent from the external apparatus to accept cancellation of the power saving mode.

Further features of the present invention will become apparent from the following description of exemplary embodiments with reference to the attached drawings.

### BRIEF DESCRIPTION OF THE DRAWINGS

FIG. 1 is a view exemplifying the configuration of an information processing system according to the first embodiment of the present invention;

FIG. 2 is a block diagram exemplifying the hardware configurations of a main system 102 and subsystem 103 according to the first embodiment of the present invention;

FIG. 3 is a block diagram for explaining the processing functions of a sub CPU 202 according to the first embodiment of the present invention;

FIG. 4 is a sequence chart exemplifying the operations of the main system 102, the subsystem 103, and another device 426 according to the first embodiment of the present invention;

FIG. 5 is a flowchart exemplifying the entire operation of the subsystem 103 according to the first embodiment of the present invention;

FIGS. 6A and 6B are flowcharts exemplifying detailed processing of the subsystem 103 when shifting to a power saving mode according to the first embodiment of the present invention;

FIG. 7 is a table exemplifying power supply control applied to a subsystem 103 in the power saving mode according to the second embodiment of the present invention; and

FIG. 8 is a table exemplifying clock control applied to the subsystem 103 in the power saving mode according to the second embodiment of the present invention.

### DESCRIPTION OF THE EMBODIMENTS

Preferred embodiments of the present invention will now be described with reference to the accompanying drawings. IEEE802.3 and IEEE802.11 will be exemplified as a wired standard and wireless standard, respectively, but the present invention is not limited to them.

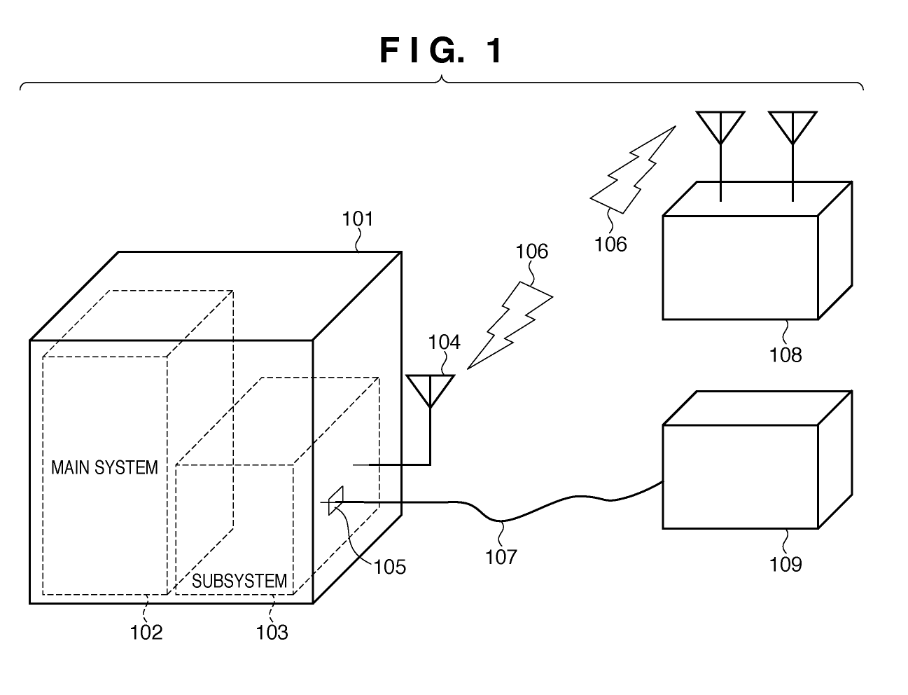

FIG. 1 shows an example of a system to which a power saving method according to the present invention is applicable.

An information processing system 101 incorporates a subsystem 103 and main system 102. The main system 102 executes an application in the information processing system 101. More specifically, the main system 102 executes an application for display when the information processing system 101 is a television, printing when it is a printer, and image capturing when it is a camera. The subsystem 103 performs processing associated with communication of the information processing system 101 that is not executed by the main system. The subsystem 103 complies with at least two communication methods. In the example of FIG. 1, the subsystem adopts two communication methods: One is wireless communication and the other is wired communication.

An external interface of wireless communication is, for example, an antenna 104, and an external interface of wired communication is, for example, a cable socket 105. Each communication interface builds a network with another device via a corresponding communication medium. For wireless communication, a network is built between the antenna 104 and a wireless communication device 108 via air 106. For wired communication, a wired network is built with a wired communication device 109 via a cable 107 connected to the cable socket 105. The information processing system 101 is assumed to support WOL and WOWLAN.

When the information processing system 101 is in the power saving mode, the main system 102 shifts to an application-stopped mode while the subsystem 103 continues wired or wireless communication. At this time, MagicPacket or a packet of a wakeup pattern having the same function as that of MagicPacket is assumed to be externally received via a wired or wireless interface. Then, the main system 102 shifts from the application-stopped mode to a normal operation mode. It is desirable that when the information processing system 101 is in the power saving mode, the subsystem 103 provides the WOL or WOWLAN function while maintaining the power saving mode. The present invention provides a power saving control method applied to such an information processing system.

### First Embodiment

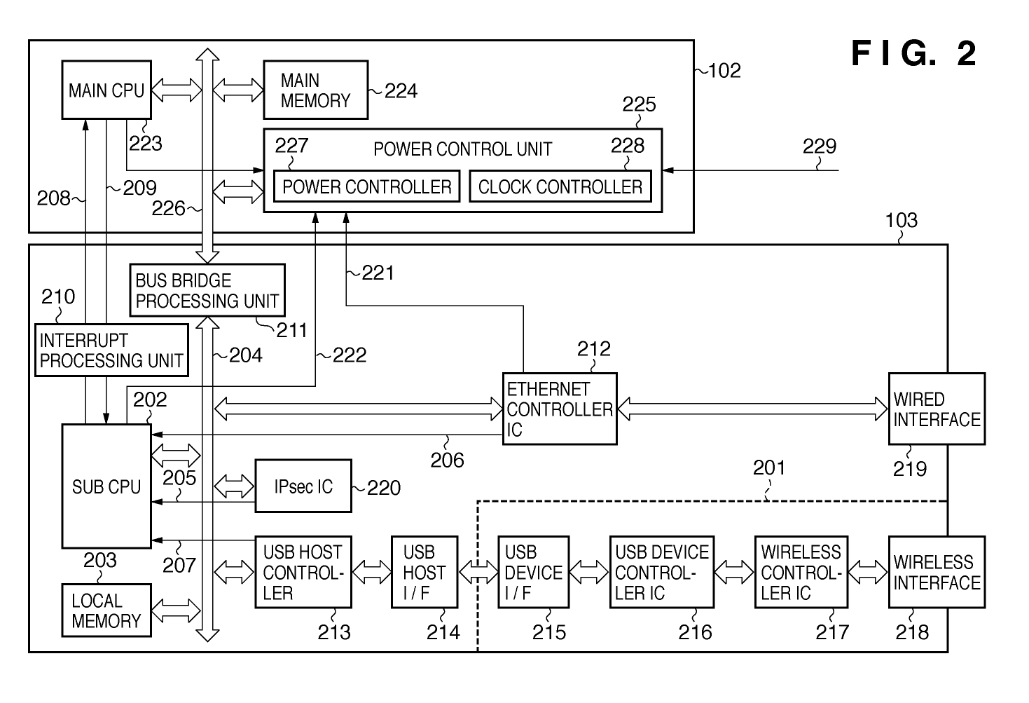

The first embodiment will be described with reference to FIG. 2. FIG. 2 is a block diagram exemplifying the hardware configurations of a main system 102 and subsystem 103 in the internal configuration of an information processing system 101.

The subsystem 103 according to the first embodiment includes the following building components. A wireless function unit 201 is formed from a USB device interface (I/F) 215 (to be described later) and the like. A sub CPU 202 performs entire processing of the subsystem 103, details of which will be described later. A local memory 203 is mounted in the subsystem 103 and prepared as a buffer memory necessary for a program to perform processing by the sub CPU 202, and transmission/reception of a communication frame.

A local bus 204 is used when the sub CPU accesses each functional block or IC. A signal line 205 sends an interrupt signal from an IPsec IC 220 (to be described later) to the sub CPU 202. The signal line 205 is used when an Ethernet® controller IC 212 (to be described later) asserts an interrupt signal to the sub CPU 202.

A signal line 206 sends an interrupt signal from the Ethernet controller IC 212 to the sub CPU 202. The signal line 206 is used when the Ethernet controller IC 212 asserts an interrupt signal to the sub CPU 202. A signal line 207 sends an interrupt signal from a USB host controller IC 213 (to be described later) to the sub CPU 202. The signal line 207 is used when the USB host controller IC 213 asserts an interrupt signal to the sub CPU 202.

A signal line 208 sends an interrupt signal from the sub CPU 202 to a main CPU 223 (to be described later). The signal line 208 is used when the sub CPU 202 asserts an interrupt signal to the main CPU 223. A signal line 209 sends an interrupt signal from the main CPU 223 to the sub CPU 202. The signal line 209 is used when the main CPU 223 asserts an interrupt signal to the sub CPU 202.

An interrupt processing unit 210 performs processing concerning an interrupt signal used between the main CPU 223 and the sub CPU 202. For example, when asserting an interrupt signal, the main CPU 223 or sub CPU 202 writes the type of interrupt in the register of the interrupt processing unit. Upon receiving the interrupt signal, the sub CPU 202 or main CPU 223 specifies the type of interrupt by accessing the register of the interrupt processing unit 210. The interrupt processing unit 210 also provides a bus arbitration function when the main CPU 223 uses the local bus 204 for access or the sub CPU 202 uses a main bus 226 (to be described later) for access.

A bus bridge processing unit 211 is used to connect the main bus 226 and local bus 204. When the main bus 226 and local bus 204 use different protocols and access across the bus is generated from the main CPU 223 or sub CPU 202, the bus bridge processing unit 211 converts the protocol.

The Ethernet controller IC 212 is the first controller which mediates communication between the sub CPU 202, the main CPU 223, and a wired interface 219 (to be described later). When the Ethernet controller IC 212 transmits data to the wired interface 219 or receives data from it, the Ethernet controller IC 212 asserts an interrupt signal to the sub CPU 202. The Ethernet controller IC 212 has a MagicPacket analysis function for WOL. The Ethernet controller IC 212 has a function of asserting an interrupt signal to a power control unit 225 (to be described later) upon detecting a specific packet such as MagicPacket.

The USB host controller IC 213 is the second controller which has USB host-side functions, and transmits/receives data via a USB host interface (I/F) 214 in accordance with a USB protocol.

The USB host I/F 214 is the USB interface of a functional block or IC having host-side functions in the USB protocol. The USB device I/F 215 is the USB interface of a functional block or IC having device-side functions in the USB protocol.

A USB device controller IC 216 has USB device-side functions, and transmits/receives data via the USB device I/F 215 or transmits/receives data to/from a wireless controller IC 217 (to be described later) in accordance with the USB protocol.

The wireless controller IC 217 analyzes data received from the USB device controller IC 216. If the data is to be sent wirelessly, the wireless controller IC 217 encodes and modulates the data in accordance with a wireless LAN protocol and transmits the resultant data to a wireless interface 218 (to be described later). Also, the wireless controller IC 217 demodulates and decodes data received via the wireless interface 218. The wireless controller IC 217 analyzes the type of demodulated/decoded data, and if it determines that the data is necessary for the sub CPU 202 or main CPU 223, transmits the data to the USB device controller IC 216.

The wireless interface 218 wirelessly transmits data received from the wireless controller IC 217 or externally receives wireless data. The wired interface 219 transmits, by wire, data received from the Ethernet controller IC 212 or externally receives wired data.

The IPsec IC 220 is a signal processing unit configured to perform cryptographic processing in an IP network. The sub CPU 202 controls the IPsec IC 220. A signal line 221 sends a wake signal from the Ethernet controller IC 212 to the power control unit 225. The signal line 221 is used when the Ethernet controller IC 212 asserts a wake signal to the power control unit 225 upon receiving MagicPacket from the wired interface 219.

A signal line 222 sends a wake signal from the sub CPU 202 to the power control unit 225. The sub CPU 202 analyzes a packet received from the wired interface 219 or wireless interface 218. When the sub CPU 202 detects, from the analysis result, a factor to return the main system from the power saving mode, it asserts a wake signal to the power control unit 225. The signal line 222 is used to assert the wake signal.

The building components of the main system 102 will be explained.

The main CPU 223 controls the applications of the overall information processing system. A main memory 224 stores programs to be executed by the main CPU 223, and functions as a buffer memory for data handled by the main CPU 223. The power control unit 225 is a functional block for controlling power of the whole information processing system. The power control unit 225 includes a power controller 227 and clock controller 228 (to be described later).

The power controller 227 may have any function as long as it can control the ON/OFF state of power supply to each predetermined part of the subsystem 103. For descriptive convenience, the power controller 227 is assumed to be able to control the power-on/off states of all the ICs, CPU, memory, and interfaces in the subsystem 103.

The clock controller 228 may have any function as long as it can control switching of the clock frequency in a predetermined part of a functional block in the subsystem 103. For descriptive convenience, the clock controller 228 is assumed to have a function capable of controlling the clock frequency of the sub CPU 202 stepwise.

Upon externally receiving a wake signal, the power control unit 225 instructs the power controller 227 to supply desired power to each IC, each functional unit, the sub CPU 202, and the local memory 203 at a predetermined wake timing. The power control unit 225 instructs the clock controller 228 to change the operation clock frequency of the sub CPU 202 to a desired one upon a wake. When shifting to the power saving mode upon normal activation, the sub CPU 202 may directly issue a control instruction to the power control unit 225 or the main CPU 223 may issue an instruction to the power control unit 225 in response to a request from the sub CPU 202.

A signal line 229 transmits a wakeup signal to the power control unit 225 independently of the main system 102 and subsystem 103. For example, the signal line 229 is used to transmit a wakeup signal to the main system 102 when press of a button by a user is detected in the information processing system including the main system 102 and subsystem 103. The signal line 229 is also used to transmit a wakeup signal by a method different from one using the subsystem 103.

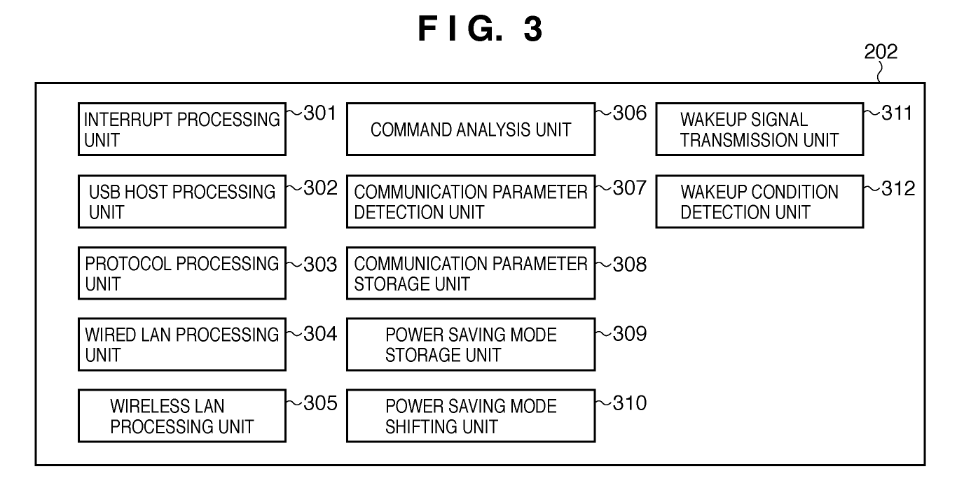

Processing units in the sub CPU 202 will be explained with reference to FIG. 3.

An interrupt processing unit 301 detects an interrupt signal asserted from the main CPU 223, Ethernet controller IC 212, IPsec IC 220, or USB host controller IC 213, and decides processing to be executed next based on the detection results.

A USB host processing unit 302 issues an instruction to send data from the local memory to the USB host controller IC 213 and then to the USB host I/F 214. In response to an interrupt signal from the USB host controller, the USB host processing unit 302 receives data from the USB host controller IC and stores it in the local memory.

A protocol processing unit 303 executes protocol processing. For descriptive convenience, the protocol processing unit 303 is assumed to perform protocol processing from the data link layer serving as the second layer to the application layer serving as the seventh layer in the OSI reference model. The protocol processing unit 303 executes desired protocol processing for data received from the main system 102 in accordance with the communication method used and the communication partner, and transmits the processed data. The protocol processing unit 303 analyzes data received from the Ethernet controller IC 212 or USB host controller IC 213, and decides the next processing. For example, when it is analyzed that data is addressed to the main system 102, the protocol processing unit 303 transmits the data to the main system 102.

A wired LAN processing unit 304 transmits a data frame to the Ethernet controller IC to transmit it to another device, or transmits a control instruction to the Ethernet controller IC. A wireless LAN processing unit 305 issues a command to a wireless LAN controller IC. If necessary, the wireless LAN processing unit 305 adds, to a data frame generated by the protocol processing unit 303, a wireless frame or a command to the wireless LAN controller IC.

A command analysis unit 306 analyzes whether data received from the main system 102 contains a command to the sub CPU 202 or subsystem 103, and analyzes the type of command. When the command analysis unit 306 determines as a result of the analysis that the command pertains to communication settings, a communication parameter detection unit 307 analyzes whether the data contains parameter settings or the like associated with communication executed by the subsystem 103. Set communication parameters include, for example, a communication medium, communication partner, communication protocol, cryptographic method, and communication rate in communication.

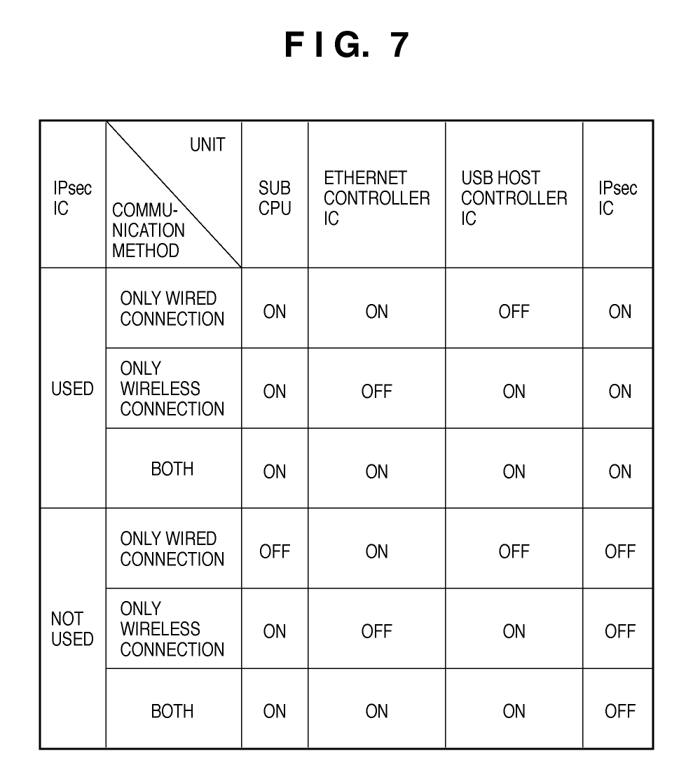

A communication parameter storage unit 308 stores communication parameters detected by the communication parameter detection unit 307. A power saving mode storage unit 309 is, for example, a table which makes communication parameters and power saving modes correspond to each other. Details of the table will be described with reference to FIG. 7.

Upon receiving a notification from the main system 102 to shift to the power saving mode, a power saving mode shifting unit 310 transmits a control instruction to the power control unit to shift the subsystem 103 to a power saving mode corresponding to the current communication state and communication parameters. Alternatively, the power saving mode shifting unit 310 transmits, to the main CPU 223, information necessary to shift the subsystem 103 to a power saving mode corresponding to the current communication state and communication parameters. Upon receiving the information, the main CPU 223 transmits a control instruction to the power control unit 225 to shift the subsystem 103 to a power saving mode, based on the information.

When a wakeup condition detection unit 312 (to be described later) detects a wakeup pattern from data received from another device, a wakeup signal transmission unit 311 transmits a wakeup signal to the power control unit 225. The wakeup condition detection unit 312 has a function of analyzing a wakeup pattern in respective layers from the data link layer to the application layer. That is, the wakeup condition detection unit 312 detects whether data received from the Ethernet controller IC 212 or USB host controller IC 213 contains a wakeup pattern. Details of this processing will be described later.

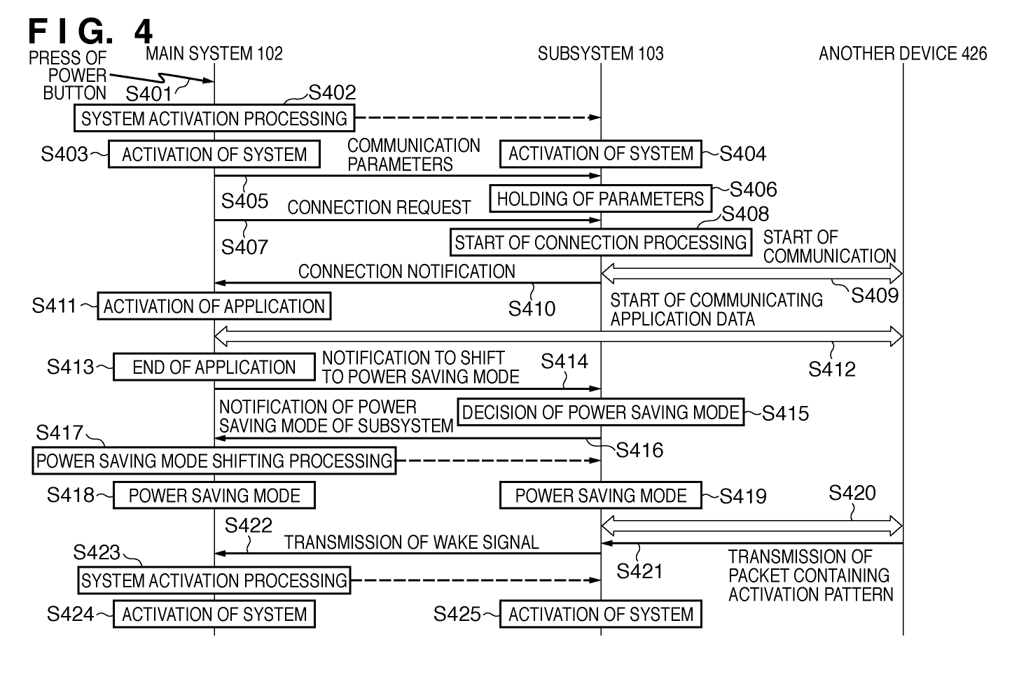

The operations of the main system 102, the subsystem 103, and another device 426 according to the first embodiment of the present invention will be described with reference to FIG. 4. FIG. 4 is a sequence chart exemplifying the operations of the main system 102, subsystem 103, and device 426 according to the first embodiment of the present invention. Note that the device 426 in FIG. 4 is the wireless communication device 108 or wired communication device 109 in FIG. 1. A detailed operation of the device 426 is not the gist of the present invention, and a description thereof will be omitted.

Referring to FIG. 4, both the main system 102 and subsystem 103 are in a power-off mode or power saving mode. In step S401, for example, the user presses the button. Then, the main system 102 performs activation processing in step S402.

In steps S403 and S404, both the main system 102 and subsystem 103 shift to the normal activation mode of the system.

In this state, the main system 102 transmits, to the subsystem 103 in step S405, parameters used for a communication method in communication connection to another device. In subsequent step S406, the subsystem 103 holds the received parameters. In step S407, the main system 102 transmits a connection request to the subsystem 103. In step S408, the subsystem 103 starts connection processing to the device 426 based on the held parameters.

In step S409, a connection between the device 426 and the subsystem 103 is established through a series of connection start processes. In step S410, the subsystem 103 notifies the main system 102 that the connection has been established. In step S411, the main system 102 which has established a connection with the device 426 activates an application. Data used by the application are exchanged between the device 426 and the main system 102. After that, in step S413, the main system 102 ends the requested application. In step S414, the main system 102 which need not execute the application any more notifies the subsystem 103 of the shift to the power saving mode.

Upon receiving the notification, the subsystem 103 determines in step S415 whether it needs to wake up the main system 102 upon receiving a packet (activation signal) containing a wakeup pattern while the main system 102 is in the power saving mode. If the subsystem 103 needs to wake up the main system 102, it decides power distribution necessary to activate the wakeup mode. Based on the power distribution, the subsystem 103 decides a power saving mode to be applied to it when the main system 102 is in the power saving mode. In step S416, the subsystem 103 notifies the main system 102 of the decided power saving mode.

In step S417, upon receiving the notification, the main system 102 performs processing to shift it to the power saving mode. At the same time, the main system 102 performs processing to shift the subsystem 103 to the power saving mode based on the notification from the subsystem 103. The main system 102 shifts to the power saving mode in step S418, and the subsystem 103 shifts to it in step S419. Note that the subsystem 103 enters a power saving mode in which the wakeup mode is active (S420).

In this state, if the subsystem 103 receives a packet containing a wakeup pattern (activation pattern) from the device 426 in step S421, the subsystem 103 causes a processing unit corresponding to an active wakeup mode to analyze the packet. Based on the analysis result, the subsystem 103 transmits a wakeup signal to the main system 102 in step S422.

Upon receiving the wakeup signal, the main system 102 starts processing in step S423 to shift from the power saving mode to the normal activation mode. In steps S424 and 5425, both the main system 102 and subsystem 103 change to the normal activation mode.

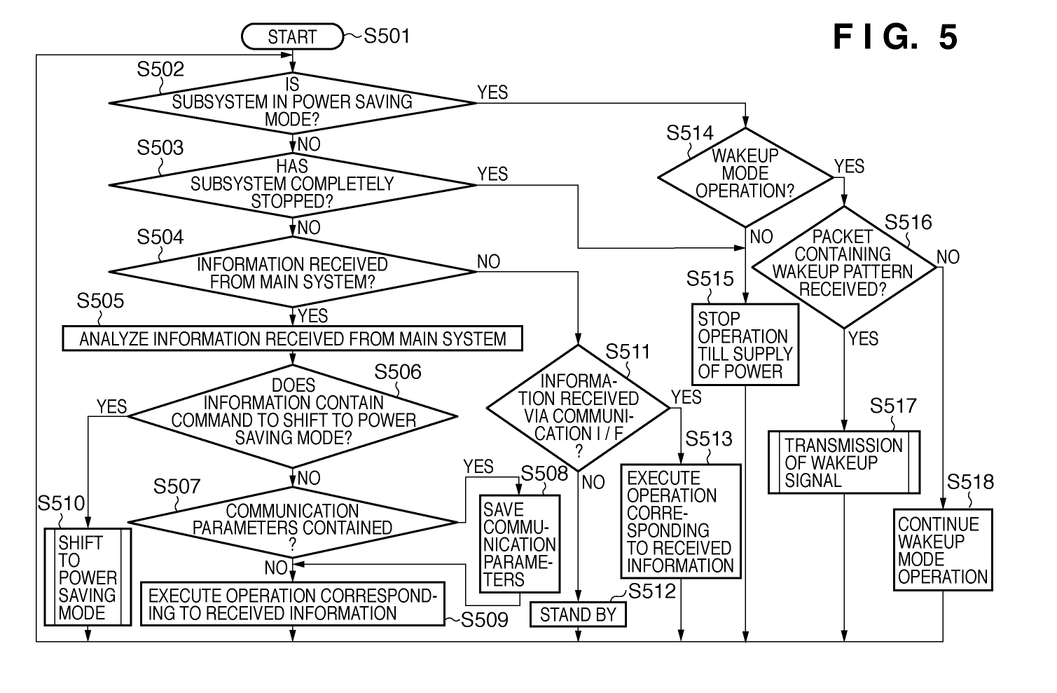

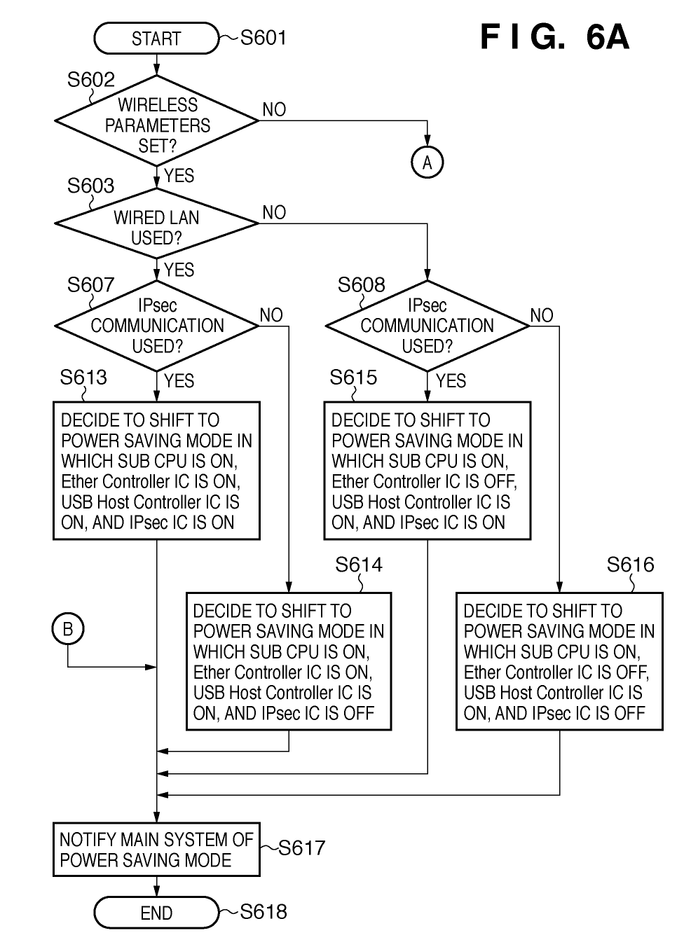

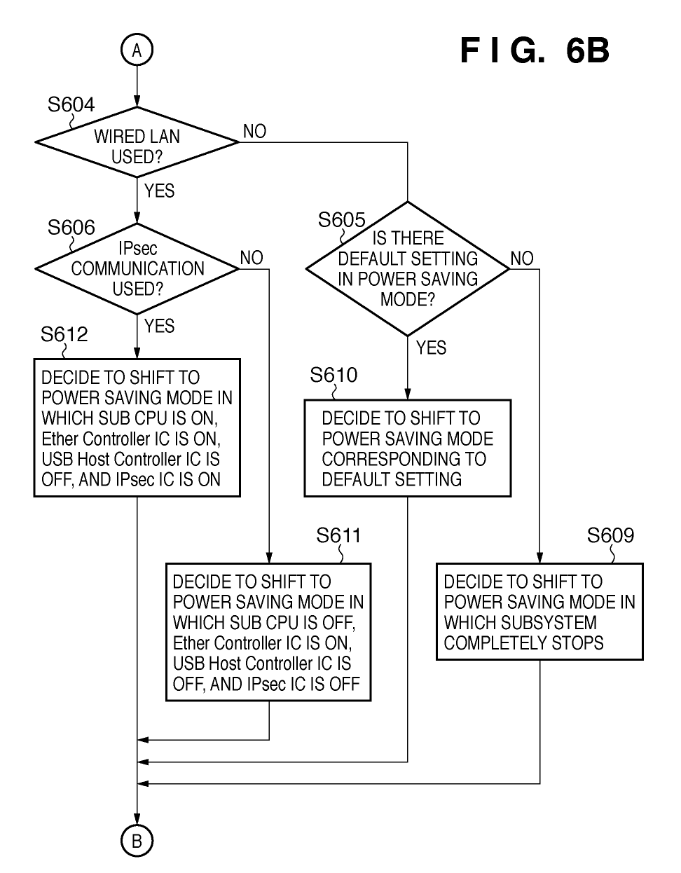

The operation of the subsystem 103 in the first embodiment of the present invention will be explained with reference to FIGS. 5 and 6. FIG. 5 is a flowchart exemplifying the entire operation of the subsystem 103 according to the first embodiment of the present invention. FIGS. 6A and 6B are flowcharts exemplifying detailed processing of the subsystem 103 when shifting to the power saving mode according to the first embodiment of the present invention. The operation in FIG. 5 will be described first.

In step S501, the operation of the subsystem 103 starts. In step S502, the process branches depending on whether the subsystem 103 is in the power saving mode. If the subsystem 103 is in the power saving mode, the process branches to step S514; if it is not in the power saving mode, the process branches to step S503.

In step S503, the process branches depending on whether power supply to the subsystem 103 has completely stopped and the subsystem 103 has completely stopped. If no power has been supplied to the subsystem 103 and the subsystem 103 has completely stopped, the process branches to step S515; if NO, the process branches to step S504.

In step S504, the process branches depending on whether the subsystem 103 has received information from the main system 102 while it is in neither the power saving mode nor completely stopped mode, that is, is in the normal activation mode. Whether the subsystem 103 has received information from the main system 102 can be determined by checking whether the main CPU 223 has transmitted an interrupt signal to the sub CPU 202. If the subsystem 103 has received information from the main system 102, the process branches to step S505; if it has not received information, to step S511. Note that when an interrupt signal is transmitted, the interrupt processing unit 301 executes interrupt processing, and the sub CPU 202 acquires the information by accessing an area where the information from the main system 102 is stored.

In step S505, the subsystem 103 analyzes the information received from the main system 102. More specifically, the command analysis unit 306 of the sub CPU 202 analyzes whether the information received from the main system 102 contains a command. If the information contains a command, the command analysis unit 306 analyzes the processing contents.

In step S506, the process branches depending on whether the information received from the main system 102 contains information on a shift of the main system 102 to the power saving mode. If the information received from the main system 102 contains information on a shift to the power saving mode, the process branches to step S510; if it contains other information, the process branches to step S507.

In step S507, the process branches depending on whether the information received by the subsystem 103 from the main system 102 contains parameter information on communication settings. The communication parameter detection unit 307 of the sub CPU 202 performs this processing. Communication parameters include various parameters such as associate information used to establish wireless communication, and the algorithm of cryptographic processing used in data communication. The cryptographic processing includes WEP, WPA, and WPA2 used in a wireless section, and IPsec commonly used in wired communication and wireless communication. Communication parameters also include registration information of MagicPacket serving as a trigger to shift the main system 102 from the power saving mode to the normal operation mode.

If the information from the main system 102 contains information on communication parameters, the process branches to step S508; if it does not contain such information, to step S509.

In step S508, when the information supplied from the main system 102 to the subsystem 103 contains communication setting parameters, the subsystem 103 saves the parameters. The communication parameter storage unit 308 of the sub CPU 202 stores the parameters in the local memory 203. The wakeup mode of the subsystem 103 when the main system 102 and subsystem 103 shift to the power saving mode is decided based on setting information of the communication parameters.

In step S509, the subsystem 103 executes various processes based on the information received by the subsystem 103 from the main system 102. For example, when the subsystem 103 receives, from the main system 102, data to be transmitted to another device, it transmits the data in an appropriate packet.

In step S510, the subsystem 103 performs a series of processes necessary to shift to the power saving mode in response to a notification that the main system 102 has shifted to the power saving mode in step S510. Details of these processes will be explained with reference to FIGS. 6A and 6B.

In step S511, the process branches depending on whether the subsystem 103 has received information from an external device via the wired interface 219 or wireless interface 218. If the subsystem 103 has received information from an external device, the process branches to step S513; if it has not received the information, the process branches to step S512.

In step S512, the subsystem 103 performs idle processing while it has not received information from both the main system 102 and an external device.

In step S513, the subsystem 103 performs processing corresponding to the information received by the subsystem 103 from an external device. For example, when the received information is application data necessary for the main system 102, the subsystem 103 notifies the main system 102 that it has received the information. Then, the subsystem 103 stores the data in a location accessible by the main system 102.

In step S514, the process branches depending on whether the subsystem 103 runs in the wakeup mode. If the subsystem 103 runs in the wakeup mode, the process branches to step S516; if it does not run in the wakeup mode, the process branches to step S515.

In step S515, power supply to the subsystem 103 has completely stopped, or even when the subsystem 103 is in the power saving mode, it does not run in the wakeup mode and does not execute any processing. Hence, the subsystem 103 stands still until the main system 102 supplies power to shift the subsystem 103 to the normal activation mode.

In step S516, the process branches depending on whether the subsystem 103 has received, from an external device, a packet containing a wakeup pattern detectable in a currently active wakeup mode. If the subsystem 103 has received a packet containing a wakeup pattern, the process branches to step S517; if it has not received a packet containing a wakeup pattern, the process branches to step S518.

In step S517, upon receiving the packet containing the wakeup pattern, the subsystem 103 transmits a wakeup signal to the main system 102. In step S518, the subsystem 103 running in the wakeup mode continues the wakeup mode operation until it receives a wakeup signal.

A detailed operation sequence of the subsystem 103 when shifting to the power saving mode will be explained with reference to FIGS. 6A and 6B.

In step S601, the subsystem 103 starts a series of processes when shifting to the power saving mode. More specifically, the series of processes starts when the subsystem 103 detects that information received by the subsystem 103 from the main system 102 contains notification information that the main system 102 has shifted to the power saving mode.

In step S602, the process branches depending on whether information for establishing wireless communication is contained in information stored in the communication parameter storage unit 308. If the information is contained, the subsystem 103 determines that an external device may wirelessly transmit a packet containing a wakeup pattern to the subsystem 103. The subsystem 103 then decides to activate a wakeup mode operation by wireless communication. If the information for establishing wireless communication is contained, the process branches to step S603; if it is not contained, the process branches to step S604.

In step S603, the process branches depending on whether a wired LAN has been connected. The sub CPU 202 causes the Ethernet controller IC to check in advance whether a valid wired LAN connection exists. Based on the result of the check, the sub CPU 202 determines whether the wired LAN has been connected. If the wired LAN connection has been used, the process branches to step S607; if it has not been used, the process branches to step S608.

Step S604 is identical to step S603. If the wired LAN connection has been used, the process branches to step S606; if it has not been used, the process branches to step S605.

In step S605, the process branches depending on whether there is a default setting requiring the wakeup mode operation of the subsystem 103 when the main system 102 is in the power saving mode. This conditional decision is made when the subsystem 103 has used neither wired communication nor wireless communication. In this state, if there is a default setting to set the wakeup mode of the subsystem 103, the process branches to step S610; if there is no such default setting, the process branches to step S609.

In step S606, the process branches depending on whether the subsystem 103 used the IPsec IC 220 when it communicated with the external device. If the subsystem 103 used the IPsec IC 220, the process branches to step S612; if it did not use the IPsec IC 220, the process branches to step S611.

Step S607 is identical to step S606. If the subsystem 103 used the IPsec IC 220, the process branches to step S613; if it did not use the IPsec IC 220, the process branches to step S614. Step S608 is also identical to step S606. If the subsystem 103 used the IPsec IC 220, the process branches to step S615; if it did not use the IPsec IC 220, the process branches to step S616.

In step S609, the subsystem 103 decides to shift to a completely stopped mode when the main system 102 is in the power saving mode. In this state, the subsystem 103 cannot communicate with an external device regardless of wireless communication or wired communication, and there is no default setting concerning the wakeup mode of the subsystem 103 when the main system 102 is in the power saving mode. Hence, the subsystem 103 determines not to use the wakeup mode of the subsystem 103 when the main system 102 is in the power saving mode.

In step S610, the subsystem 103 decides to shift to a power saving mode corresponding to default settings when the main system is in the power saving mode. The default settings can be obtained by acquiring user setting information in advance and notifying the subsystem 103 of it by the main system 102. The default settings include a setting of shifting to a power saving mode in a wakeup mode in which the subsystem 103 uses only the MagicPacket detection function of the Ethernet controller IC 212 in a wired LAN. When an Ethernet cable is connected to establish a valid wired network, the main system 102 can return to the normal activation mode in response to MagicPacket transmitted from an external device. In this case, the subsystem 103 can supply power to only the Ethernet controller IC 212 while stopping power supply to the remaining units.

In step S611, the subsystem 103 controls power supply to each IC of it as follows, and decides to shift to a power saving mode:

The sub CPU 202 . . . OFF

The Ethernet controller IC 212 . . . ON

The USB host controller IC 213 . . . OFF

The IPsec IC 220 . . . OFF

Under this condition, only a wired connection is used, and the IPsec IC 220 is not used. The subsystem 103 activates only the Ethernet controller IC 212 when the main system 102 is in the power saving mode. Only when the Ethernet controller IC 212 detects MagicPacket, the subsystem 103 executes a wakeup operation. A wakeup signal at this time is sent from the Ethernet controller IC 212 to the power control unit 225 of the main system 102.

In step S612, the subsystem 103 controls power supply to each IC of it as follows, and decides to shift to a power saving mode:

The sub CPU 202 . . . ON

The Ethernet controller IC 212 . . . ON

The USB host controller IC 213 . . . OFF

The IPsec IC 220 . . . ON

Under this condition, only a wired connection is used, and the IPsec IC 220 is used. The subsystem 103 activates the Ethernet controller IC 212, the IPsec IC 220, and the sub CPU 202 for controlling the IPsec IC 220 when the main system 102 is in the power saving mode. The subsystem 103 can use the sub CPU to analyze an encrypted packet in the IP protocol.

Hence, the subsystem 103 can provide a variety of functions in addition to a function of transmitting a wakeup signal from the subsystem 103 only when the Ethernet controller IC 212 receives MagicPacket. For example, even if a packet is encrypted in the IP protocol, the subsystem 103 can send back a response upon receiving a protocol on a layer above the IP protocol, such as a TCP protocol or SNMP protocol.

The main system 102 which normally receives a user request may request these processes of the sub CPU 202. Instead, these processes may be reflected in default settings. That is, it may be set as a default to always respond to reception of a packet containing a given protocol as long as the sub CPU 202 is active.

Note that the subsystem 103 of the present invention can provide various wakeup modes when the sub CPU 202 in the subsystem 103 is active.

The wakeup condition detection unit 312 will be explained. For example, the Ethernet controller IC 212 is assumed to have only the MagicPacket detection function. However, a wakeup operation can be executed by registering a wakeup pattern in the sub CPU 202 by a user setting in advance. In this case, the sub CPU 202 analyzes a wakeup pattern and transmits a wakeup signal. Wakeup processes in various layers can be provided in accordance with protocols used in the protocol processing unit 303.

This means that even a printer in a power saving mode can return to a normal activation mode upon receiving print start data from an external device in an information processing system having a printer function and the like.

Detection of a wakeup pattern by the sub CPU 202 includes detection of a simple specific digital data sequence by hardware processing, and in addition, detection of a result of conditional decision by software.

In step S613, the subsystem 103 controls power supply to each IC of it as follows, and decides to shift to a power saving mode:

The sub CPU 202 . . . ON

The Ethernet controller IC 212 . . . ON

The USB host controller IC 213 . . . ON

The IPsec IC 220 . . . ON

Under this condition, both wired and wireless connections are used, and the IPsec IC 220 is used. The subsystem 103 needs to turn on all the sub CPU 202, Ethernet controller IC 212, USB host controller IC 213, and IPsec IC 220 when the main system 102 is in the power saving mode. Accordingly, the subsystem 103 can process data transmitted via both wired and wireless connections even in the power saving mode, and can execute cryptographic analysis of the IP protocol. Under this condition, however, the power saving effect of the subsystem 103 cannot be achieved by only power control.

In step S614, the subsystem 103 controls power supply to each IC of it as follows, and decides to shift to a power saving mode:

The sub CPU 202 . . . ON

The Ethernet controller IC 212 . . . ON

The USB host controller IC 213 . . . ON

The IPsec IC 220 . . . OFF

Under this condition, both wired and wireless connections are used, and the IPsec IC 220 is not used. The subsystem 103 decides to turn off only the IPsec IC 220 when the main system 102 is in the power saving mode. The subsystem 103 can therefore process data transmitted via both wired and wireless connections even in the power saving mode.

In step S615, the subsystem 103 controls power supply to each IC of it as follows, and decides to shift to a power saving mode:

The sub CPU 202 . . . ON

The Ethernet controller IC 212 . . . OFF

The USB host controller IC 213 . . . ON

The IPsec IC 220 . . . ON

Under this condition, only a wireless connection is used, and the IPsec IC 220 is used. The subsystem 103 decides to turn off only the Ethernet controller IC 212 when the main system 102 is in the power saving mode. Since no wired LAN is usable, the subsystem 103 uses a wakeup mode in which the sub CPU 202 detects a wakeup pattern from a packet received via a wireless LAN and transmits a wakeup signal to the main system 102.

In step S616, the subsystem 103 controls power supply to each IC of it as follows, and decides to shift to a power saving mode:

The sub CPU 202 . . . ON

The Ethernet controller IC 212 . . . OFF

The USB host controller IC 213 . . . ON

The IPsec IC 220 . . . OFF

Under this condition, only a wireless connection is used, and the IPsec IC 220 is not used. The subsystem 103 decides to turn off the Ethernet controller IC 212 and IPsec IC 220 when the main system 102 is in the power saving mode. Since no wired LAN is usable, the subsystem 103 uses a wakeup mode in which the sub CPU 202 detects a wakeup pattern from a packet received via a wireless LAN and transmits a wakeup signal to the main system 102. Step S616 is different from step S615 in that a packet encrypted by the IP protocol cannot be analyzed.

In step S617, the subsystem 103 notifies the main system 102 of the power saving mode the subsystem 103 decides to apply when the main system 102 is in the power saving mode. If possible, the subsystem 103 may directly request control of the power control unit 225. When only the main CPU 223 can control the power control unit 225, it suffices that the sub CPU 202 notifies the main CPU 223 of a power saving mode applied to the subsystem 103, and the main CPU 223 sends a request to the power control unit 225.

In step S618, a series of processes ends, including decision of a power saving mode and wakeup mode applied to the subsystem 103 when the main system 102 is in the power saving mode, and notification of a request to the main system 102.

A detailed operation of the subsystem 103 has been described with reference to the flowcharts of FIGS. 6A and 6B.

Note that power saving modes in the embodiment can be roughly classified into two. In the first power saving mode, power is supplied to the Ethernet controller IC 212 without supplying power to the sub CPU 202. In this case, the WOL function of the Ethernet controller IC 212 is used for return from the power saving mode. No wireless connection is used for external communication, and the IPsec IC 220 is not used, either.

In the second power saving mode, power is supplied to the sub CPU 202, and the sub CPU 202 controls return from the power saving mode. In this case, it does not matter whether to use either or both of wired and wireless connections, and whether to use the IPsec IC 220.

To efficiently decide a power saving mode, for example, the power saving mode storage unit 309 can store a table as shown in FIG. 7. In this case, the processing shown in FIGS. 6A and 6B can be easily achieved by comparing communication parameters stored in the communication parameter storage unit 308 with the registration contents of the table in FIG. 7. The table in FIG. 7 sets communication parameters “only wired connection”, “only wireless connection”, and “both”, and whether or not to use the “IPsec IC 220” for each of the three connection forms. The ON/OFF states of the sub CPU 202, Ethernet controller IC 212, USB host controller IC 213, and IPsec IC 220 are registered for each condition.

The first embodiment can control the power saving mode of the subsystem stepwise in accordance with use/non-use of WOL or WOWLAN and the contents of processing requested of the subsystem. The first embodiment can return the system from the power saving mode based on a return request transmitted via a wired or wireless connection, like WOL or WOWLAN, while suppressing wasteful power consumption of the subsystem.

### Second Embodiment

The first embodiment of the present invention has been described, but is merely an example of the present invention. The present invention may also be embodied as follows.

For example, before or simultaneously when a main system 102 notifies a subsystem 103 that the main system 102 shifts to a power saving mode, an operation requested of the subsystem 103 in the power saving mode may be designated. Assume that the subsystem 103 is instructed to respond to a specific protocol in a packet transmitted from an external device even when the main system 102 is in the power saving mode. By instructing the subsystem 103 to operate in this way, an information processing system to which the present invention is applied can be externally detected even in the power saving mode. It can also be controlled to always operate a sub CPU 202 even in the power saving mode of the subsystem 103 by giving top priority to the instruction received from the main system 102 upon a shift to the power saving mode.

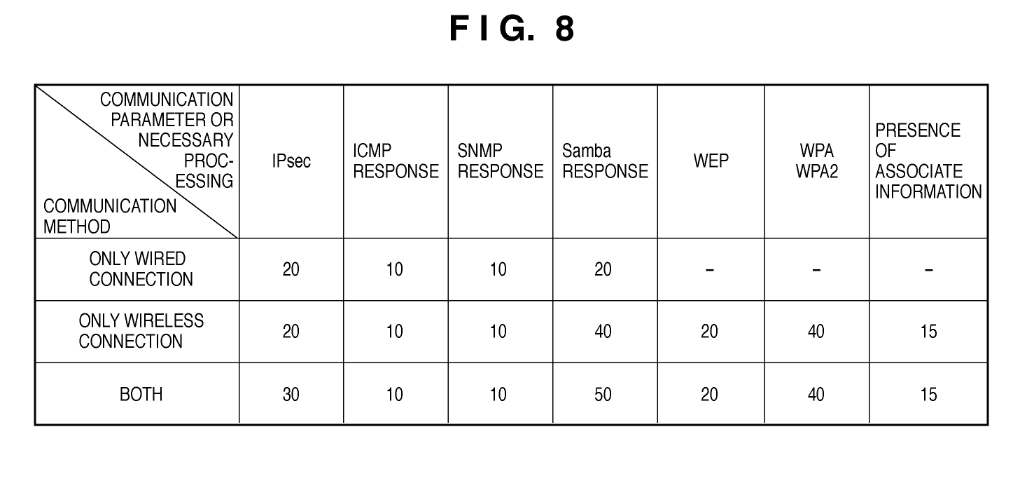

Even in a situation in which the sub CPU 202 always runs, the power saving effect can be obtained by controlling a clock frequency supplied to the sub CPU 202 to reduce power consumption of the sub CPU 202. For example, a table concerning clock control can be prepared in a power saving mode storage unit 309, in addition to the power control table in FIG. 7. FIG. 8 shows an example of this table. The table in FIG. 8 describes a clock rate requested using, as indices, the communication method, the communication parameter, and necessary processing in the sub CPU 202.

Examples of the communication parameter and necessary processing in the sub CPU 202 are communication using an IPsec IC 220, response processing for an ICMP protocol, and response processing upon receiving an SNMP protocol. The table in FIG. 8 also describes response processing upon receiving a Samba protocol, WEP and WPA/WPA2 encryption processes in use of a wireless connection, and wireless connection maintenance processing based on associate information.

A figure described in FIG. 8 indicates the ratio of a clock frequency requested by each processing when the maximum clock frequency in operation is set to a ratio of 100. For example, a 20-MHz clock frequency is required to perform communication using the IPsec IC 220 by only a wired connection when the maximum clock frequency of the sub CPU 202 is 100 MHz. ICMP packet response processing requires a clock frequency of 30 MHz which is the sum of 20 for communication using the IPsec IC 220 and 10. A table may also be prepared to uniquely decide a clock frequency according to a combination of processes. A decided clock frequency can be applied by transmitting it from the sub CPU 202 to the main system 102 together with the above-described IC power control information.

The clock frequency can be set in correspondence with each communication parameter used in actual communication. In this case, power saving control by clock control of the sub CPU 202 can be achieved flexibly with communication settings other than those in FIG. 8.

The controller incorporated in the subsystem to execute each communication processing in the present invention can be arbitrarily implemented. The controller is mounted as an IC in the first embodiment, but may be mounted in, for example, the same chip as that of the sub CPU 202 in the second embodiment. At this time, the present invention is applicable as long as power or a clock supplied to the chip can be independently supplied to each block in the chip.

This also applies to the wireless function unit 201 in the first embodiment. In the first embodiment, the wireless function unit 201 is mounted on a board different from that supporting the sub CPU 202, and these boards are connected by a USB interface. However, the wireless function unit 201 may be mounted on the same board or chip as that of the sub CPU 202 which controls the subsystem 103.

The power saving control method to which the present invention is applicable can be applied to power control other than the above-described IC power control in the power saving mode. For example, a case will be considered, in which all the functions of a wireless function unit 201 are supplied via a USB device I/F 215. In this case, based on whether wireless communication is used, the subsystem 103 determines whether to supply power to the USB device I/F 215. The subsystem 103 notifies the main system 102 of the determination result, improving the power saving effect.

As described above, the second embodiment of the present invention can reduce power consumption of even the subsystem while operating WOL or WOWLAN in the information processing system which is in a low-power consumption mode while operating WOL or WOWLAN.

Resultantly, the second embodiment can improve the power consumption reduction effect of the overall information processing system.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-251685, filed Sep. 29, 2008, which is hereby incorporated by reference herein in its entirety.

What is claimed is:

1. An information processing system comprising a main system which executes an application, and a subsystem which controls communication with an external apparatus,
the information processing system having a power saving mode in which power consumption of the information processing system is reduced,
said main system including a power control unit configured to control power consumption of said subsystem,
said subsystem including:
a first communication processing unit configured to communicate with the external apparatus;
a second communication processing unit configured to communicate with the external apparatus; and
a control unit for said subsystem,
wherein when the information processing system shifts to the power saving mode, said power control unit controls power consumption of said subsystem in the power saving mode in accordance with a type of instruction sent from the external apparatus to accept cancellation of the power saving mode.

2. The system according to claim 1, wherein said power control unit controls power supply to at least said first communication processing unit, said second communication processing unit, and said control unit.

3. The system according to claim 1, wherein said power control unit controls an operation clock of said control unit.

4. The system according to claim 1, wherein said power control unit controls power consumption of said subsystem in the power saving mode in accordance with at least one of a use state of said first communication processing unit, a use state of said second communication processing unit, and a use state of cryptographic communication.

5. The system according to claim 1, wherein power consumption of said subsystem in the power saving mode is controlled in accordance with whether to use a signal processing unit commonly used in communication by said first communication processing unit and communication by said second communication processing unit.

6. The system according to claim 1, further comprising a signal processing unit commonly used by said first communication processing unit and said second communication processing unit,
wherein said power control unit controls power consumption of said subsystem in the power saving mode in accordance with at least a use state of said first communication processing unit, a use state of said second communication processing unit, and a use state of said signal processing unit commonly used in communication by said first communication processing unit and communication by said second communication processing unit.

7. The system according to claim 1, wherein when a signal from the external apparatus to designate cancellation of the power saving mode is detected, said first communication processing unit transmits an activation signal to said power control unit to designate return from the power saving mode.

8. The system according to claim 1, wherein said control unit determines, based on data received from the external apparatus, whether to return from the power saving mode, and when said control unit determines to return from the power saving mode, transmits an activation signal to said power control unit to designate return.

9. The system according to claim 8, wherein when the data received from the external apparatus is either of a packet designating return from the power saving mode and data for use by the application of said main system, said control unit determines to return from the power saving mode.

10. The system according to claim 1, wherein said first communication processing unit includes a communication processing unit configured to perform wired communication.

11. The system according to claim 1, wherein said second communication processing unit includes a communication processing unit configured to perform wireless communication.

12. An information processing system comprising a main system which executes an application, and a subsystem which controls communication with an external apparatus,
said main system including:
an acquisition unit configured to acquire information on a power saving mode of said subsystem from said subsystem; and
a power control unit configured to control power supply to said main system and said subsystem, said subsystem including:
a first controller which performs wired communication with the external apparatus;
a second controller which performs wireless communication with the external apparatus; and
a control unit for said subsystem,
wherein when said subsystem shifts to the power saving mode, said power control unit controls power supply to at least said control unit, said first controller, and said second controller in accordance with the information acquired by said acquisition unit, and
the power saving mode includes a first power saving mode in which power is supplied to said first controller without supplying power to said control unit, and a second power saving mode in which power is supplied to said control unit and at least either of said first controller and said second controller.

13. The system according to claim 12, wherein
said subsystem includes a signal processing unit configured to perform signal processing for data received from the external apparatus,
when said subsystem shifts to the power saving mode, said power control unit further controls power supply to said signal processing unit, and when power is supplied to said signal processing unit, supplies power to said control unit, and
the signal processing for data received from the external apparatus includes cryptographic processing.

14. The system according to claim 12, wherein in the first power saving mode, when said first controller detects a predetermined packet transmitted from the external apparatus, said first controller transmits an activation signal to said power control unit to designate return from the power saving mode.

15. The system according to claim 12, wherein in the second power saving mode, said control unit determines, based on data received from the external apparatus, whether to return from the power saving mode, and when said control unit determines to return from the power saving mode, transmits an activation signal designating return to said power control unit.

16. The system according to claim 15, wherein when the data received from the external apparatus is either of a specific packet designating return from the power saving mode and data for use by the application of said main system, said control unit determines to return from the power saving mode.

17. The system according to claim 12, wherein
said main system further includes a clock control unit configured to control a clock frequency supplied to said control unit, and
when said power control unit supplies power to said control unit in the second power saving mode, said clock control unit controls the clock frequency supplied to said control unit to reduce power consumption of said control unit.

18. The system according to claim 12, wherein the power saving mode of said subsystem is decided based on which of wired communication and wireless communication is used to accept a request to return said main system from the power saving mode.

19. An information processing system comprising a main system which executes an application, and a subsystem which controls external communication,
said main system including a control unit configured to control power supply to said subsystem,
said subsystem including:
a first controller which performs wired communication;
a second controller which performs wireless communication; and
a control unit for said subsystem,
wherein when said subsystem shifts to a power saving mode, said control unit controls power supply to said control unit, said first controller, and said second controller in accordance with a communication standby state of said subsystem.

20. The system according to claim 19, wherein the power saving mode includes a first power saving mode in which power is supplied to said first controller without supplying power to said control unit, and a second power saving mode in which power is supplied to said control unit and at least either of said first controller and said second controller.

21. A method of controlling an information processing system including a main system which executes an application, and a subsystem including a first communication processing unit and second communication processing unit configured to communicate with an external apparatus, and a control unit, the information processing system having a power saving mode in which power consumption of the information processing system is reduced, the method comprising:
determining whether to shift the information processing system to the power saving mode; and
when the information processing system shifts to the power saving mode, controlling power consumption of the subsystem in the power saving mode in accordance with a type of instruction sent from the external apparatus to accept cancellation of the power saving mode.
